(19) United States
(12) Patent Application Publication
(10) Pub. No.: US 2009/0275463 A1
(43) Pub. Date: Nov. 5, 2009

(54) METHOD OF MAKING A CATALYST WASHCOAT

(75) Inventors: Hrishikesh Keshavan, Clifton Park, NY (US); Robert Joseph Lyons, Burnt Hills, NY (US); Larry Neil Lewis, Scotia, NY (US); Dan Hancu, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/113,260

(22) Filed: May 1, 2008

(51) Int. Cl. B01J 23/08; B01J 21/00; B01J 29/04; B01J 19/08; B01J 21/18; B01J 23/00

(52) U.S. Cl. 502/60; 502/232; 502/350; 502/349; 502/355; 502/351; 502/180; 427/299; 427/560

(57) ABSTRACT

A method for making a catalyst includes providing a sol that sol includes a catalyst and a catalyst substrate; drying the sol via freeze-drying, spray drying, freeze granulation, or supercritical fluid drying to form a powder; mixing the powder with a solvent to form a slurry; and washcoating the slurry onto a catalyst support. Another method for making a catalyst includes providing a sol, wherein the sol includes a catalyst substrate; drying the sol via freeze-drying, spray drying, freeze granulation, or supercritical fluid drying to form a powder; mixing the powder with a solvent to form a slurry; washcoating the slurry onto a catalyst support; and depositing a catalyst onto the catalyst substrate.

### TECHNICAL FIELD

The invention includes embodiments that relate to a catalyst. The invention includes embodiments that relate to a method of making a catalyst.

### DISCUSSION OF ART

Regulations continue to evolve regarding the reduction of the oxide gases of nitrogen (NOx) for diesel engines in trucks and locomotives. NOx gases may be undesirable. A NOx reduction solution may include treating diesel engine exhaust with a catalyst that can reduce NOx to N₂ and O₂ using a reductant. This process may be referred to as selective catalytic reduction or SCR.

In selective catalytic reduction (SCR), a reductant, such as ammonia, is injected into the exhaust gas stream to react with NOx in contact with a catalyst. Where ammonia is used, the molecule forms nitrogen and water. Three types of catalysts have been used in these systems. The types include base metal systems, noble metal systems, and zeolite systems. The noble metal catalysts operate in a low temperature regime (240 degrees Celsius to 270 degrees Celsius), but may be inhibited by the presence of SO₂. Base metal catalysts operate in the intermediate temperature range (310 degrees Celsius to 400 degrees Celsius), but at high temperatures they may promote oxidation of SO₂ to SO₃. These base metal catalysts may include vanadium pentoxide and titanium dioxide. The zeolites may withstand temperatures up to 600 degrees Celsius and, when impregnated with a base metal, have a wide range of operating temperatures.

Hydrocarbons (HC) may also be used in the selective catalytic reduction of NOx emissions. NOx can be selectively reduced by a variety of organic compounds (e.g. alkanes, olefins, alcohols) over several catalysts under excess O₂ conditions. The injection of diesel or methanol has been explored in heavy-duty stationary diesel engines to supplement the HC in the exhaust stream. However, the conversion efficiency may be reduced outside the narrow temperature range of 300 degrees Celsius to 500 degrees Celsius. In addition, there may be other undesirable properties.

Selective catalytic reduction catalysts may include catalytic metals disposed upon a porous substrate. However, these catalysts may not function properly when NOx reduction is desired during use. Catalyst preparation and deposition on a substrate may be involved and complex. The structure and/or efficacy of the catalyst substrate may be compromised during manufacture. It may be desirable to have a method of processing such catalysts that does not compromise the catalyst activity.

### BRIEF DESCRIPTION

In one embodiment, a method for making a catalyst is provided. A sol may be used, where the sol includes a catalyst and a catalyst substrate. The sol may be dried to form a powder. Suitable drying methods may include one or more of freeze-drying, spray drying, freeze granulation, solvent drying, high humidity drying, or supercritical fluid drying. The powder may be mixed with a solvent to form a slurry. The slurry may be washcoated onto a catalyst support.

In one embodiment, a method for making a catalyst is provided. A sol comprises a catalyst substrate; the sol is dried via freeze-drying, spray drying, freeze granulation, or supercritical fluid drying to form a powder. The powder is mixed with a solvent to form a slurry. The slurry is washcoated onto a catalyst support. A catalyst is deposited onto the catalyst substrate.

### BRIEF DESCRIPTION OF THE DRAWINGS

FIG. 1 illustrates an ultrasonic milling setup used in accordance with an embodiment of the invention.

FIG. 2 illustrates an effect of ultrasonic milling on mesoporous alumina powder.

### DETAILED DESCRIPTION

The invention includes embodiments that relate to a method of making a catalyst. The catalyst is processed in a manner that reduces the catalyst particle size without substantially reducing, degrading or altering its catalytic activity. The catalyst may selectively catalytically reduce a content of a determined species (e.g., NOx, CO, CO₂) in an exhaust gas stream in contact therewith.

As used herein, without further qualifiers mesoporous refers to a material containing pores with diameters in a range of from about 2 nanometers to about 50 nanometers. A catalyst is a substance that can cause a change in the rate of a chemical reaction without itself being consumed in the reaction. A slurry is a mixture of a liquid and finely divided particles. A sol is a colloidal solution. A powder is a substance including finely dispersed solid particles. Monolith includes a honeycomb monolith, open flow ceramic honeycomb, wall-flow honeycomb, honeycomb monolith body, or a metal honeycomb. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

In one embodiment, the method includes drying a sol to form a powder from the sol constituents. The sol includes a catalyst substrate, a catalyst, and a solvent.

A suitable catalyst support may include one or more of alumina, silica, or titanate. Other suitable catalyst support may include a metal carbide or metal nitride. Another suitable catalyst support may include cordierite, mullite, carbon, zeolite, or other refractory oxide. More suitable materials for the catalyst support may include silicon carbide, fused silica, activated carbon, or aluminum titanate. Cordierite is magnesium iron aluminium cyclosilicate. Zeolite, as used herein, may include hydrated aluminosilicates, such as analcime, chabazite, heulandite, natrolite, phillipsite, and stilbite. Mullite, as used herein, is a form of aluminium silicate. Suitable materials may include those with a low thermal expansion along at least one axis.

The catalyst support may have a surface area greater than about 0.5 m²/gram. In one embodiment, the surface area is in a range of from about 0.5 m²/gram to about 10 m²/gram, from about 10 m²/gram to about 100 m²/gram, from about 100 m²/gram to about 200 m²/gram, or from about 200 m²/gram to about 1200 m²/gram. In one embodiment, the catalyst support has a surface area that is in a range from about 0.5 m²/gram to about 200 m²/gram.

Suitable catalysts may include one or more of gallium, indium, rhodium, palladium, ruthenium, and iridium. Other suitable catalysts may include transition metal elements. Suitable catalysts may include one or more of platinum, gold and silver. In one embodiment, the catalyst is silver.

Suitable solvents include protic solvents. Examples of solvents include water and short chain alcohols. Suitable short chain alcohols may include one or more of methanol, ethanol, hexanol, iso-propanol, 1-butanol, 2-butanol, iso-butanol, t-butanol, and the like. In one embodiment, the solvent is water.

With regard to drying the sol to form a powder, the sol may be dried in a manner that controls and reduces the particle size of the catalyst substrate sufficiently that the catalyst substrate may be effectively washcoated onto a catalyst support. In addition, a drying technique may preserve or maintain the pore structure of catalyst substrate and the efficacy of the catalyst. The preserved pore structure of the catalyst support may be a mesoporous or microporous structure. In one embodiment, the pore structure is templated or controlled to have a defined pattern, size/volume, and distribution.

While not interchangeable, suitable drying techniques include freeze-drying, spray drying, freeze granulation, supercritical fluid drying, solvent drying, and high humidity drying. The choice of drying method may be selected with reference to one or more of the material properties of the catalyst support, the catalyst, the processing parameters (dwell time, agitation rate, temperature), and the like. For example, freeze-drying or lyophilization may be performed using such equipment as rotary evaporators, manifold freeze dryers, and tray freeze dryers. The sublimation and desorption processes may control final properties of the material so formed.

Regardless of the drying process selected, the sol may be dried at a temperature in a range from about negative 150 degrees Celsius to about negative 55 degrees Celsius, from about negative 55 degrees Celsius to about 30 degrees Celsius, or from about 30 degrees Celsius to about 50 degrees Celsius. The temperature at which the sol is dried may depend upon such factors as the drying method used, and the selection of the specific catalyst substrate, catalyst and solvent present in the sol.

In one embodiment, the sol is dried via freeze-drying. During freeze-drying, the sol is first frozen and then sublimed under low pressure. The sol may be freeze-dried at a temperature in a range of from about negative 150 degrees Celsius to about 50 degrees Celsius. In one embodiment, the sol is freeze-dried at a temperature between about −55 degrees Celsius to about 30 degrees Celsius.

The drying process produces a finely divided powder. If desired, the resulting powder may be milled to control or reduce the size of the powder particles. The mesoporous or microporous structure of the catalyst substrate may be preserved through any post-processing. Suitable methods for milling the powder include ultrasonic milling, jet milling, ball milling, and planetary milling.

In one embodiment, the powder is ultrasonically milled. Ultrasonic milling uses acoustic energy to pulverize the powder. A crystal vibrating at a determined frequency may power an ultrasonic horn. The ultrasonic energy forms bubbles that travel a certain distance and implode causing comminution of the powder. The size, strength, frequency of implosions and the distance traveled are determined by the surface tension and boiling point of the liquid medium. Selecting the proper liquid medium, frequency, amplitude and time of the process can optimize the ultrasonic milling. In one embodiment, the powder is milled via an ultrasonic milling flow through set up, such as VIBRA-CEL, which is commercially available from SONICS & MATERIALS, INC.

The stability of a catalyst washcoat may relate to such properties as the particle size, morphology, activity and porosity of the catalyst. The powder formed from the sol includes particles having an average diameter that is less than about 100 micrometers. In one embodiment, the average diameter is in a range of from about 100 micrometers to about 50 micrometers, from about 50 micrometers to about 25 micrometers, from about 25 micrometers to about 10 micrometers, from about 10 micrometers to about 1 micrometer, or less than 1 micrometer. In one embodiment, the average particle diameter is in a range of from about 0.1 micrometer to about 1 micrometer. In one embodiment, the average particle diameter is in a range of from about 1 micrometer to about 18 micrometers.

During preparation, the powder is mixed with a solvent to form the slurry. Suitable solvents for forming the slurry include protic fluids. One suitable solvent is water. Another suitable solvent is a short chain alcohol, where the carbon count is less than about 20 carbon per hydroxyl. Suitable short chain alcohols may include methanol, ethanol, iso-propanol, 1-butanol, 2-butanol, iso-butanol, and t-butanol.

The slurry may be contacted to the catalyst support. In one embodiment, the slurry is washcoated onto a low surface area catalyst support such as a monolith. The washcoat slurry is contacted with the catalyst support. In one embodiment of the invention, the catalyst support is a monolith included of cordierite.

The applied washcoat is dried. Suitable drying methods include the application of convection air-drying, microwave, radiowave, vacuum drying, solvent drying, or cryo-drying. The dried washcoat is then calcined at a temperature greater than about 500 degrees Celsius. In one embodiment, the calcine temperature is in a range of from about 500 degrees Celsius about 750 degrees Celsius, from about 750 degrees Celsius about 900 degrees Celsius, from about 900 degrees Celsius to about 1000 degrees Celsius, or from about 1000 degrees Celsius to about 1200 degrees Celsius. In one embodiment, the calcine temperature is about 1150 degrees Celsius. The parameters used for drying and calcining the washcoat are selected based on the specific catalyst substrate, catalyst, and solvent used in the washcoat slurry.

In one embodiment, the sol includes the catalyst substrate but does not include a catalyst, and the following steps are implemented. After calcination of the washcoat, a catalyst is impregnated on the washcoated catalyst substrate. If desired, a combination of two or more catalysts may be impregnated on the catalyst substrate. The catalyst is deposited via the washcoat, including immersing the catalyst support in a catalyst compound one or more times to achieve the desired catalyst concentration. The washcoated catalyst substrate may be dried and calcined.

### EXAMPLES

The following examples illustrate methods and embodiments in accordance with the invention, and as such should not be construed as imposing limitations upon the claims. Unless specified otherwise, all components are commercially available from common chemical suppliers such as Alpha Aesar, Inc. (Ward Hill, Mass.), Spectrum Chemical Mfg. Corp. (Gardena, Calif.), and the like.

### Example 1

### Ultrasonic Milling of Mesoporous Alumina Powder

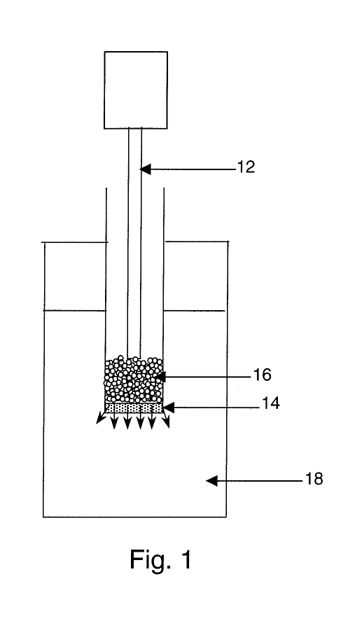

Mesoporous alumina powder is sieved in a sieve shaker to obtain a 60 mesh (<˜350 μm) powder. The ultrasonic milling setup used to reduce the particle size is schematically shown in FIG. 1. The setup includes an ultrasonic probe 12, and a 15 micrometer nylon mesh indicated by reference numeral 14. Agglomerates that are less than 15 micrometers in diameter move through the mesh and are not milled further. This avoids repetitive milling for particles of appropriate size.

The amplitude is set to #2, which corresponds to approximately ⅕ of the total power of the sonicator. The mesoporous alumina powder 16 is milled in small batches of approximately 0.3 grams for 15 minutes using water as the liquid medium. The liquid medium is indicated by reference numeral 18. After 15 minutes, another batch is added to the existing powder in the tube. This process is repeated four times. At the end of the fourth batch, all of the remaining powder in the tube is removed and a fresh set of powder is milled. Agglomerates that are too hard to be milled are removed from the tube.

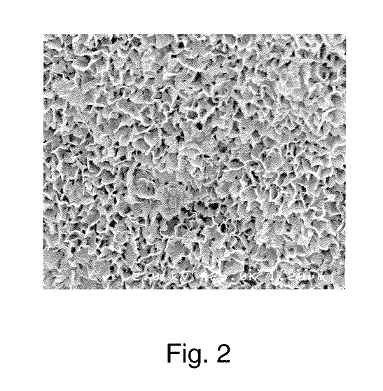

The powder collected in the bottom of the beaker is dried in a rotary evaporator at a temperature of up to 100 degrees Celsius at a pressure of 50 mTorr. The powder is calcined at 550 degrees Celsius. The calcined powder is imaged. As displayed in FIG. 2, the ultrasonic milling reduces the particle size of the mesoporous alumina to an extent that it can form a slurry. The slurry is suitable for washcoating. FIG. 2 indicates that the mesoporous structure is not destroyed as a result of ultrasonic milling.

### Example 2

### Preparation of Mesoporous Alumina Catalyst via Freeze-Drying

An aqueous sol includes water, the hydroxide form of aluminum, a templating agent, and a surface modifier, is freeze dried in a commercial freeze dryer. The templating agent is TRITON X 114. The surface modifier is ethyl acetoacetate.

In a first sample, the sol is frozen at negative 55 degrees Celsius under low pressure at 300 millitorr and slowly heated stepwise at 5 degrees Celsius until the shelf temperature is 30 degrees Celsius. At each temperature step, the soak time is 240 minutes. A fine powder forms from the sol into an aqueous slurry. The slurry is washcoated onto a substrate. The washcoated slurry is calcined at 550 degrees Celsius.

In a second sample, the freeze-dried powder is calcined before washcoating. For relatively increased adhesion, the freeze-dried powder may be calcined a second time after washcoating.

Characterization of the resultant product from samples 1 and 2 indicates that each process produces a mesoporous alumina powder having a narrow particle size mono-modal distribution. The pore distribution is templated or patterned, and is not random or uncontrolled. The pore sizes are about uniform and have an internal diameter of about 50 nanometers. Contacting the resultant product from samples 1 and 2 to an exhaust gas stream containing determined species (e.g., NOx) in the presence of a reductant at temperature reduces the amount of determined species in the exhaust gas stream.

All ranges disclosed herein are inclusive of the endpoints, and the endpoints are combinable with each other. The terms “first,” “second,” and the like as used herein do not denote any order, quantity, or importance, but rather are used to distinguish one element from another. The use of the terms “a” and “an” and “the” and similar referents in the context of describing the invention (especially in the context of the following claims) are to be construed to cover both the singular and the plural, unless otherwise indicated herein or contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for making a catalyst, comprising:
drying a sol that comprises a catalyst and a catalyst substrate by freeze-drying, spray drying, freeze granulation, or supercritical fluid drying to form a powder;
ultrasonically milling the powder;
mixing the milled powder with a solvent to form a slurry; and
washcoating the slurry onto a catalyst support, wherein the catalyst is capable of reducing an amount of determined species in an exhaust gas stream contacted therewith.

2. The method as defined in claim 1, wherein the sol is dried by freeze-drying.

3. The method as defined in claim 8, wherein drying the sol comprises selecting a temperature that is in a range of from about negative 150 degrees Celsius to about 50 degrees Celsius.

4. The method as defined in claim 1, further comprising selecting the sol to comprise water.

5. The method as defined in claim 1, further comprising selecting the sol to comprise a short chain alcohol.

6. The method as defined in claim 1, further comprising selecting the catalyst from gallium, indium, rhodium, palladium, ruthenium, or iridium.

7. The method as defined in claim 1, further comprising selecting the catalyst from platinum, gold or silver.

8. The method of claim 1, further comprising selecting the catalyst substrate from alumina, silica, titania, or zirconia.

9. The method as defined in claim 8, wherein the catalyst substrate is mesoporous alumina.

10. The method as defined in claim 1, wherein the catalyst support is a monolith.

11. The method as defined in claim 1, wherein the catalyst support has a surface area in a range of from about 0.5 m²/gram to about 650 m²/gram.

12. The method as defined in claim 1, further comprising selecting the catalyst support from cordierite, alumina, silicon carbide, or aluminum titanate.

13. The method as defined in claim 1, further comprising selecting the catalyst support from activated carbon or a zeolite.

14. The method as defined in claim 1, wherein forming the powder comprises producing particles having an average diameter that is less than or equal to about 100 micrometers

15. The method as defined in claim 14, wherein forming the powder comprises producing particles having an average diameter that is less than or equal to about 50 micrometers.

16. The method as defined in claim 1, further comprising milling the powder prior to mixing the powder with a solvent.

17. The method as defined in claim 1, further comprising drying the washcoat, and calcining the washcoat.

18. A monolith comprising the catalyst formed by the process as defined in claim 1, and the determined species in the exhaust gas stream is NOx.

19. A method for making a catalyst, comprising:
drying a sol that comprises a catalyst substrate to form a powder;
mixing the powder with a solvent to form a slurry;
washcoating the slurry onto a catalyst support; and
depositing a catalyst onto the catalyst substrate, wherein the catalyst is capable of reducing an amount of a determined species in an exhaust gas stream contacted therewith.

20. The method as defined in claim 19, wherein drying comprises freeze-drying, spray drying, freeze granulation, solvent drying, high humidity drying, or supercritical fluid drying.

21. The method as defined in claim 19, further comprising drying the washcoat, and calcining the washcoat prior to depositing the catalyst.

22. The method as defined in claim 19, further comprising calcining the washcoat after depositing the catalyst.

23. The method as defined in claim 19, further comprising selecting the catalyst from gallium, indium, rhodium, palladium, ruthenium, or iridium.

24. The method as defined in claim 19, further comprising selecting the catalyst from silver, gold or platinum.

25. The method as defined in claim 19, further comprising selecting the catalyst substrate from alumina, silica, titania, or zirconia.

26. The method as defined in claim 25, wherein the catalyst substrate is mesoporous alumina.

27. The method as defined in claim 19, further comprising selecting the solvent for the sol from water or short chain alcohols.

28. The method as defined in claim 19, wherein drying the sol comprises selecting a temperature that is in a range of from about negative 150 degrees Celsius to about 50 degrees Celsius.

29. The method as defined in claim 19, further comprising milling the powder prior to mixing the powder with a solvent.

30. The method as defined in claim 29, wherein milling comprises ultrasonic milling, jet milling, ball milling, or planetary milling.
